(19) United States
(12) Patent Application Publication
(10) Pub. No.: US 2012/0246389 A1
(43) Pub. Date: Sep. 27, 2012

(54) NONVOLATILE SEMICONDUCTOR MEMORY DEVICE AND MEMORY SYSTEM

(76) Inventor: Hiroyuki NAGASHIMA, Yokohama-shi (JP)

(21) Appl. No.: 13/235,433

(22) Filed: Sep. 18, 2011

(30) Foreign Application Priority Data
Mar. 22, 2011 (JP) 2011-063281

(51) Int. Cl. G06F 12/00; G06F 12/02

(52) U.S. Cl. 711/103; 711/154; 711/E12.001; 711/E12.008

(57) ABSTRACT

According to one embodiment, a nonvolatile semiconductor memory device includes a nonvolatile memory, and a controller having a first mode to perform data transfer in response to one of a rising edge and falling edge of a first control signal and a second mode to perform data transfer in response to both of a rising edge and falling edge of a second control signal. The controller switches the first and second modes in data input and data output.

### CROSS-REFERENCE TO RELATED APPLICATIONS

This application is based upon and claims the benefit of priority from prior Japanese Patent Application No. 2011-063281, filed Mar. 22, 2011, the entire contents of which are incorporated herein by reference.

### FIELD

Embodiments described herein relate generally to a nonvolatile semiconductor memory device and a memory system.

### BACKGROUND

As a nonvolatile semiconductor memory device that is electrically erasable and programmable and can be formed with high integration density, a NAND flash memory is known. Generally, the NAND flash memory performs a data transfer operation with respect to a host in response to one of a rising edge and falling edge of a clock.

### BRIEF DESCRIPTION OF THE DRAWINGS

FIG. 1 is a block diagram of a NAND flash memory according to a first embodiment;

FIG. 2 is a circuit diagram of a memory cell array;

FIG. 3 is a diagram illustrating the operation of setting a data transfer mode;

FIGS. 4A and 4B are flow diagrams illustrating the operation of switching a data transfer mode to an SDR mode;

FIGS. 5A and 5B are flow diagrams illustrating the operation of switching a data transfer mode to a DDR mode;

FIG. 6 is a timing chart illustrating a data input process in the SDR mode;

FIG. 7 is a timing chart illustrating a data output process in the SDR mode;

FIG. 8 is a timing chart illustrating a data input process in the DDR mode;

FIG. 9 is a timing chart illustrating a data output process in the DDR mode;

FIGS. 10A and 10B are flow diagrams illustrating the operation of switching data input and data output to an SDR mode and DDR mode, respectively;

FIGS. 11A and 11B are flow diagrams illustrating the operation of switching data input and data output to a DDR mode and SDR mode, respectively; and

FIG. 12 is a block diagram of a memory system according to a third embodiment.

### DETAILED DESCRIPTION

In general, according to one embodiment, there is provided a nonvolatile semiconductor memory device comprising:

a nonvolatile memory; and

a controller having a first mode to perform data transfer in response to one of a rising edge and falling edge of a first control signal and a second mode to perform data transfer in response to both of a rising edge and falling edge of a second control signal,

wherein the controller switches the first and second modes in data input and data output.

The embodiments will be described hereinafter with reference to the accompanying drawings. In the description which follows, the same or functionally equivalent elements are denoted by the same reference numerals, to thereby simplify the description.

### First Embodiment

### 1. Configuration of Nonvolatile Semiconductor Memory Device

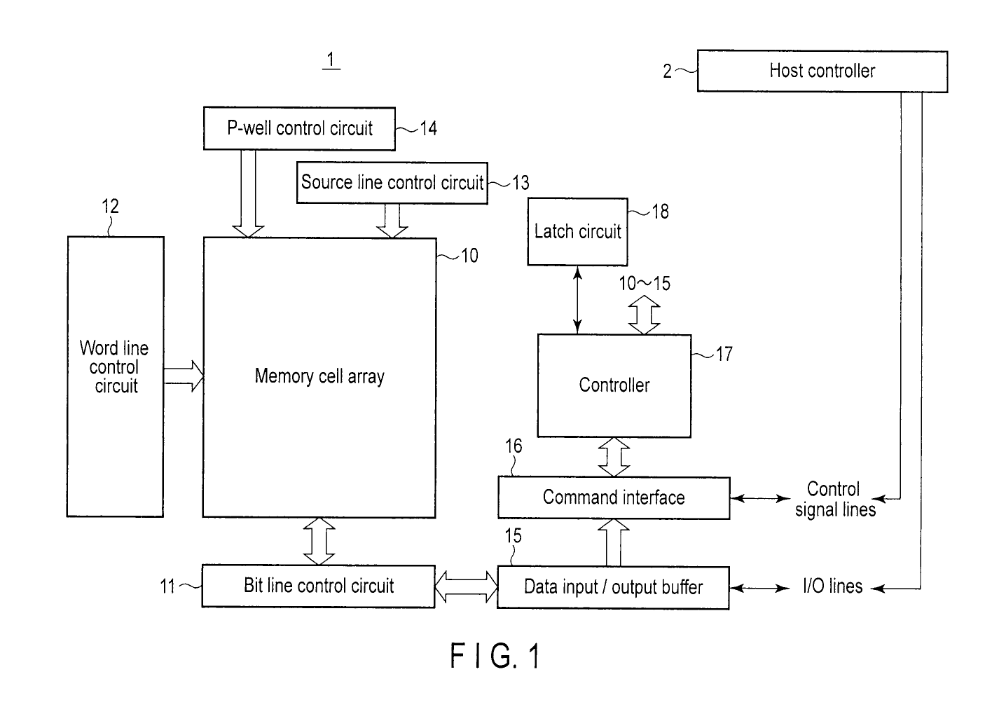

FIG. 1 is a block diagram of a NAND flash memory 1 as a nonvolatile semiconductor memory device according to a first embodiment. The NAND flash memory 1 is connected to a host device (host controller) 2 via input/output lines (I/O lines) and control signal lines.

A memory cell array 10 is configured by arranging electrically erasable and programmable flash memory cells in a matrix form. In the memory cell array 10, a plurality of bit lines BL extending in a column direction, a plurality of word lines WL extending in a row direction and source line SL extending in the row direction are arranged.

Bit lines BL are connected to a bit line control circuit 11. The bit line control circuit 11 selects one of bit lines BL and controls the voltage of bit line BL to perform data erase of a memory cell, data write to a memory cell and data read from a memory cell. The bit line control circuit 11 includes a column decoder, sense amplifier SA, page buffer and the like.

Word lines WL are connected to a word line control circuit 12. The word line control circuit 12 selects one of word lines WL and applies a voltage required for erase, write or read to word line WL. The word line control circuit 12 includes a row decoder, word line driver and the like.

A source line control circuit 13 controls the voltage of source line SL. A p-well control circuit 14 controls the voltage of a p-type well on which the memory cell array 10 is formed.

A data input/output buffer 15 is connected to the host controller 2 via the I/O lines to receive write data, output read data and receive an address and command. The data input/output buffer 15 supplies the received write data to the bit line control circuit 11 and receives read data read from the bit line control circuit 11. Further, the data input/output buffer 15 supplies an address from the host controller 2 to the bit line control circuit 11 and word line control circuit 12 via a controller 17 to select one of the memory cells. Additionally, the data input/output buffer 15 supplies a command from the host controller 2 to a command interface 16.

The command interface 16 receives various control signals from the host controller 2 via the control signal lines and supplies the control signals to the controller 17. Further, the command interface 16 determines whether data input to the data input/output buffer 15 is write data, command data or address data and, if data is a command, it receives the command and supplies the same as a command signal to the controller 17.

The controller 17 controls the whole portion of the NAND flash memory. The controller 17 interprets a command from the host controller 2 to perform various operations such as data input/output, read, write (program), and erase. Further, the controller 17 has an SDR (Single Data Rate) mode and DDR (Double Data Rate) mode as a data transfer mode for data transfer with the host controller 2. The SDR mode is a mode in which data transfer is performed in response to one of the rising edge and falling edge of the control signal. The DDR mode is a mode in which data transfer is performed in response to both of the rising edge and falling edge of the control signal, that is, it is a high-rate transfer mode. Therefore, if the same control signal is used, the DDR mode has a data transfer rate that is twice that in the SDR mode. The controller 17 performs a data transfer process with respect to the host controller 2 by using the SDR mode and DDR mode.

A latch circuit 18 stores various set data items required for the operation of the NAND flash memory 1 under control of the controller 17. The controller 17 performs various operations while confirming various set data items stored in the latch circuit 18. Further, the latch circuit 18 stores mode data used for determining which one of the SDR mode and DDR mode is used. The controller 17 determines the mode data stored in the latch circuit 18 to confirm whether the present data transfer mode is set to the SDR mode or DDR mode. As the latch circuit 18, a volatile memory is used.

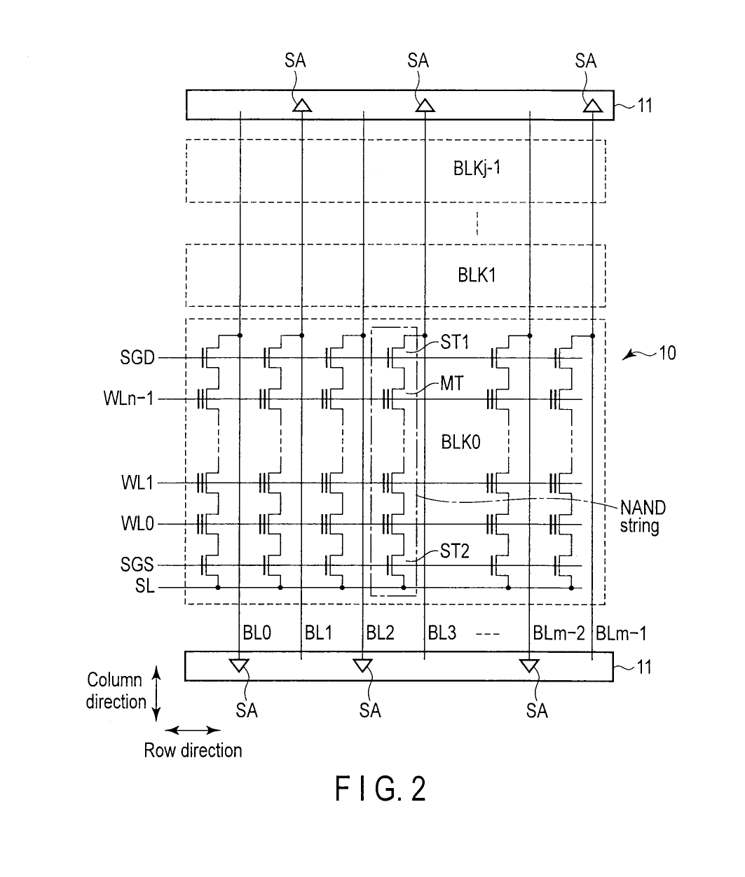

FIG. 2 is a circuit diagram of the memory cell array 10. The memory cell array 10 includes j blocks BLK0 to BLKj−1 (j is an integral number greater than 0). Block BLK is the minimum unit of data erase.

Each block BLK includes m NAND strings sequentially arranged in the row direction (m is an integral number greater than 0). The drains of select transistors ST1 included in the NAND strings are connected to corresponding bit lines BL and the gates thereof are commonly connected to select gate line SGD. The sources of select transistors ST2 included in the NAND strings are commonly connected to source line SL and the gates thereof are commonly connected to select gate line SGS.

Each memory cell transistor (also referred to as a memory cell) MT is configured by a MOSFET (Metal Oxide Semiconductor Field Effect Transistor) having a stacked gate structure formed on the p-type well. The stacked gate structure has a charge storage layer (floating gate electrode) formed above the p-type well with a gate insulating film disposed therebetween and a control gate electrode formed above the floating gate electrode with a gate-gate insulating film disposed therebetween. The threshold voltage of memory cell transistor MT varies according to the number of electrons stored in the floating gate electrode and the transistor stores data according to a difference in the threshold voltage. Memory cell transistor MT may be configured to store binary data (one-bit data) or store multilevel data (data of two or more bits).

The structure of memory cell transistor MT is not limited to the floating gate structure having the floating gate electrode and may be a structure such as a MONOS (Metal-Oxide-Nitride-Oxide-Silicon) structure whose threshold voltage may be adjusted by trapping electrons on the interface of the nitride film as the charge storage layer. Memory cell transistor MT with the MONOS structure may be similarly configured to store binary data or store multilevel data.

In each NAND string, n (n is an integral number greater than 0) memory cell transistors MT are arranged between the source of select transistor ST1 and the drain of select transistor ST2 to have the current paths thereof serially connected. That is, every adjacent two of n memory cell transistors MT commonly use a diffusion region (source/drain region) and the memory cell transistors are serially connected in the column direction.

In each NAND string, the control gate electrodes are sequentially connected to respective word lines WL0 to WLn−1 starting from memory cell transistor MT that is arranged closest to the source side. Therefore, the drain of memory cell transistor MT connected to word line WLn−1 is connected to the source of select transistor ST1 and the source of memory cell transistor MT connected to word line WL0 is connected to the drain of select transistor ST2.

Each of word lines WL0 to WLn−1 commonly connects the control gate electrodes of corresponding memory cell transistors MT of the NAND strings in block BLK. That is, the control gate electrodes of memory cell transistors MT arranged on the same row are connected to the same word line WL. In this case, m memory cell transistors MT connected to the same word line WL are dealt with as one page and data write and data read are performed for each page.

Further, each of bit lines BL0 to BLm−1 commonly connects the drains of select transistors ST1 in blocks BLK. That is, the NAND strings on the same column in blocks BLK0 to BLKj−1 are connected to the same bit line BL. Each bit line BL is connected to a corresponding one of sense amplifiers SA included in the bit line control circuit 11.

The configuration example in which each bit line BL is connected to one sense amplifier SA is shown in FIG. 2, but each sense amplifier SA can be arranged for two bit lines.

### 2. Operation

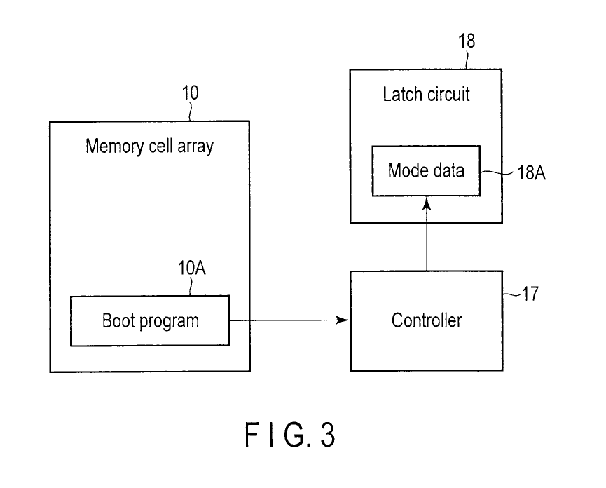

The operation of the NAND flash memory 1 with the above configuration is explained. First, the operation of setting a data transfer mode at the boot time (start time) of the NAND flash memory 1 is explained. FIG. 3 is a diagram illustrating the operation of setting the data transfer mode.

The memory cell array 10 includes a storage area 10A that stores a boot program used at the boot time of the NAND flash memory 1. At the power-on time, the controller 17 reads the boot program from the storage area 10A of the memory cell array 10 and performs the initialization operation by using the boot program. In the boot program, mode data of a default for determining the data transfer mode is included and the controller 17 stores the mode data in a storage area 18A of the latch circuit 18. Subsequently, the controller 17 performs a data transfer mode specified by the mode data stored in the latch circuit 18.

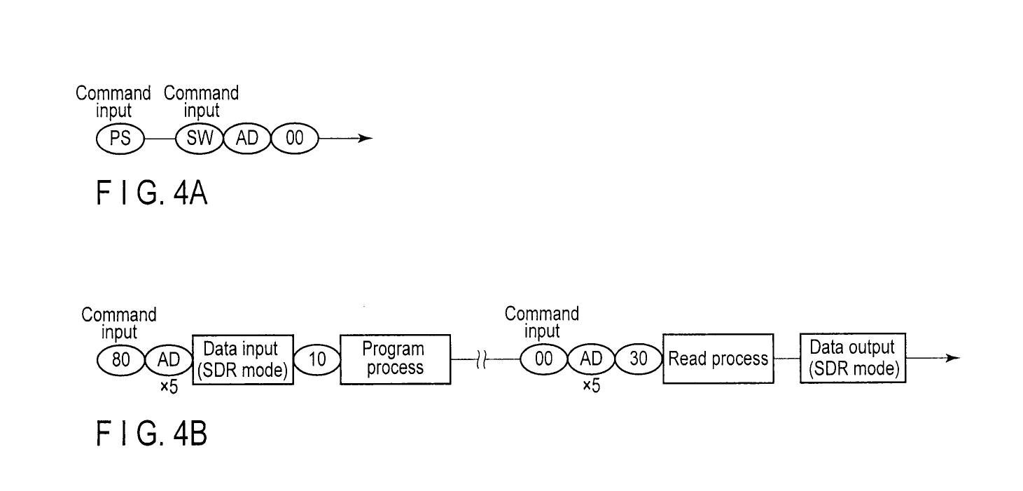

Next, the switching operation of the data transfer mode is explained. FIG. 4A is a flow diagram illustrating the operation of switching a data transfer mode to an SDR mode. Numbers in FIGS. 4A and 4B are expressed in hexadecimal number notation and one ellipse represents data of eight bits (one byte). As shown in FIGS. 4A and 4B, one command is defined by eight bits, for example.

First, the NAND flash memory 1 receives set command sequence PS from the host controller 2. Set command sequence PS may be one set command shown in FIG. 4A or a set command sequence including a plurality of commands.

Then, the controller 17 receives a switch command sequence from the host controller 2. The switch command sequence includes switch command SW, address AD and parameter “00h”. The least significant bit of the parameter specifies a data transfer mode in data output and the second bit from the least significant bit specifies a data transfer mode in data input. Data “0” represents an SDR mode and data “1” represents a DDR mode. Since the lower two bits of parameter “00h” included in the switch command sequence of FIG. 4A are “00b”, the data transfer modes in data output and data input are both specified to the SDR mode.

After interpreting the switch command sequence, the controller 17 overwrites mode data that sets the data transfer modes in data output and data input to the SDR mode to the storage area 18A of the latch circuit 18. Subsequently, the NAND flash memory 1 confirms mode data stored in the latch circuit 18 to perform data output and data input with respect to the host controller 2 by using the SDR mode.

The command sequence is defined as the command for switching the data transfer mode, but the command sequence is not limited to the above case. For example, the data transfer mode may be switched only by using the switch command or the data transfer mode may be switched only by using the parameter.

FIG. 4B is a flow diagram illustrating the data input operation and data output operation in the SDR mode. The NAND flash memory 1 receives a program command sequence and data from the host controller 2. The program command sequence includes command “80h”, address and command “10h”. Address AD of one byte in an address at the program time is defined by data of five cycles, for example.

In response to the program command sequence, the controller 17 performs a data input process by using the SDR mode. Then, the controller 17 writes data received from the host controller 2 to the memory cell array 10 in the page unit. Likewise, the program command sequence is repeatedly performed until all of write data items requested by the host controller 2 are written to the NAND flash memory 1.

Next, the NAND flash memory 1 receives a read command sequence from the host controller 2. The read command sequence includes command “00h”, address and command “30h”. Address AD of one byte in an address at the read time is defined by data of five cycles, for example.

In response to the read command sequence, the controller 17 reads data corresponding to an address from the memory cell array 10 in the page unit. Then, the controller 17 performs a data output process by using the SDR mode. Likewise, the read command sequence is repeatedly performed until all of read data items requested by the host controller 2 are read from the NAND flash memory 1.

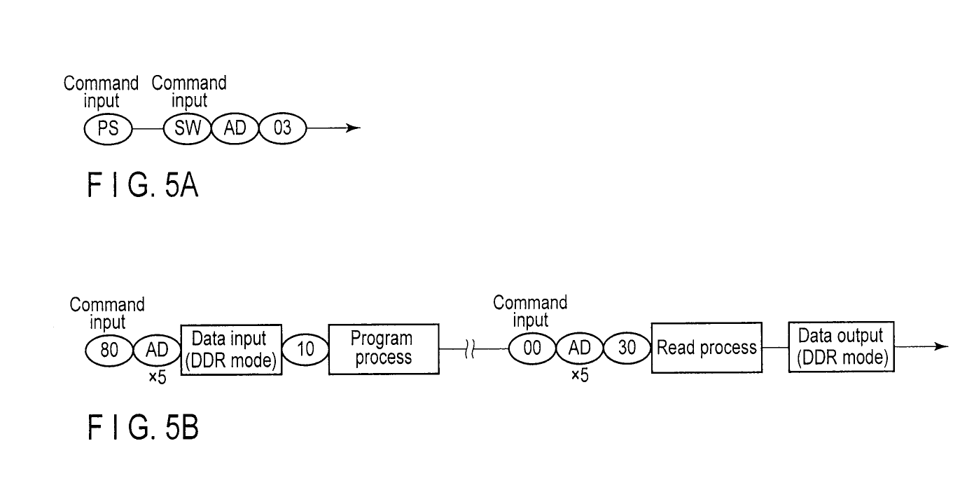

FIG. 5A is a flow diagram illustrating the operation of switching the data transfer mode to the DDR mode. First, the NAND flash memory 1 receives set command sequence PS from the host controller 2.

Then, the controller 17 receives a switch command sequence from the host controller 2. The switch command sequence includes switch command SW, address AD and parameter “03h”. Since the lower two bits of parameter “03h” are “11b”, the data transfer modes in data output and data input are both specified to the DDR mode.

After interpreting the switch command sequence, the controller 17 overwrites mode data used for setting both of the data transfer modes in data output and data input to the DDR mode to the storage area 18A of the latch circuit 18. Then, the NAND flash memory 1 confirms mode data stored in the latch circuit 18 to perform data output and data input with respect to the host controller 2 by using the DDR mode.

FIG. 5B is a flow diagram illustrating the data input operation and data output operation in the DDR mode. The NAND flash memory 1 receives a program command sequence and data from the host controller 2. In response to the program command sequence, the controller 17 performs a data input process by using the DDR mode. Then, the controller 17 writes data received from the host controller 2 to the memory cell array 10 in the page unit. Likewise, the program command sequence is repeatedly performed until all of write data items requested by the host controller 2 are written to the NAND flash memory 1.

Next, the NAND flash memory 1 receives a read command sequence from the host controller 2. In response to the read command sequence, the controller 17 reads data corresponding to an address from the memory cell array 10 in the page unit. Then, the controller 17 performs a data output process by using the DDR mode. Likewise, the read command sequence is repeatedly performed until all of read data items requested by the host controller 2 are read from the NAND flash memory 1.

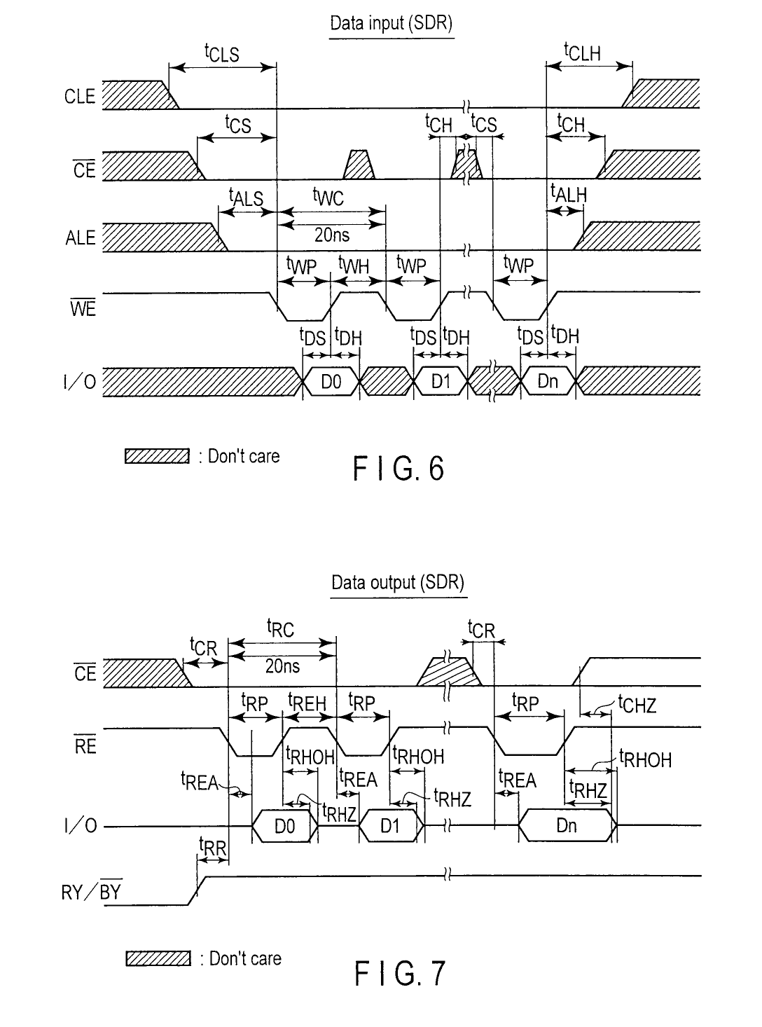

FIG. 6 is a timing chart illustrating a data input process in the SDR mode. The NAND flash memory 1 receives command latch enable signal CLE, chip enable signal /CE, address latch enable signal ALE and write enable signal /WE as control signals from the host controller 2. In this case, t_{CLS}, t_{CS}, t_{ALS} and t_{PS} indicate setup time, t_{CLH}, t_{CH}, t_{ALH} and t_{DH} indicate hold time, t_{WC} indicates write cycle time, t_{WP} indicates write pulse width and t_{WH} indicates high-hold time of /WE.

As shown in FIG. 6, the controller 17 takes in input data D in response to the rising edge of write enable signal /WE. That is, the controller 17 performs a data input process by using the SDR mode with write enable signal /WE used as a control signal. The cycle time (write cycle time t_{WC}) of write enable signal /WE is 20 ns, for example. Therefore, in the data input process in the SDR mode, the transfer rate of 50 Mbps is realized.

FIG. 7 is a timing chart illustrating a data output process in the SDR mode. The NAND flash memory 1 receives chip enable signal /CE and read enable signal /RE as controls signals from the host controller 2 and supplies ready/busy signal RY//BY as a control signal to host controller 2. In this case, t_{CR} indicates a time ranging from the time when /CE becomes low to the time when /RE becomes low, t_{RC} indicates read cycle time, t_{RP} indicates read pulse width, t_{REH} indicates high-hold time of /RE, t_{CHZ} indicates a time from the time when /CE becomes high to the time when output high impedance is attained, t_{RHOH} indicates output hold time after /RE becomes high, t_{REA} indicates /RE access time, t_{RHZ} indicates a time from the time when /RE becomes high to the time when output high impedance is attained, and t_{RR} indicates a time from the ready state to the falling edge of /RE.

As shown in FIG. 7, the controller 17 outputs data in response to the rising edge of read enable signal /RE. That is, the controller 17 performs a data output process by using the SDR mode with read enable signal /RE used as a control signal. The cycle time (read cycle time t_{RC}) of read enable signal /RE is 20 ns, for example. Therefore, in the data output process in the SDR mode, the transfer rate of 50 Mbps is realized.

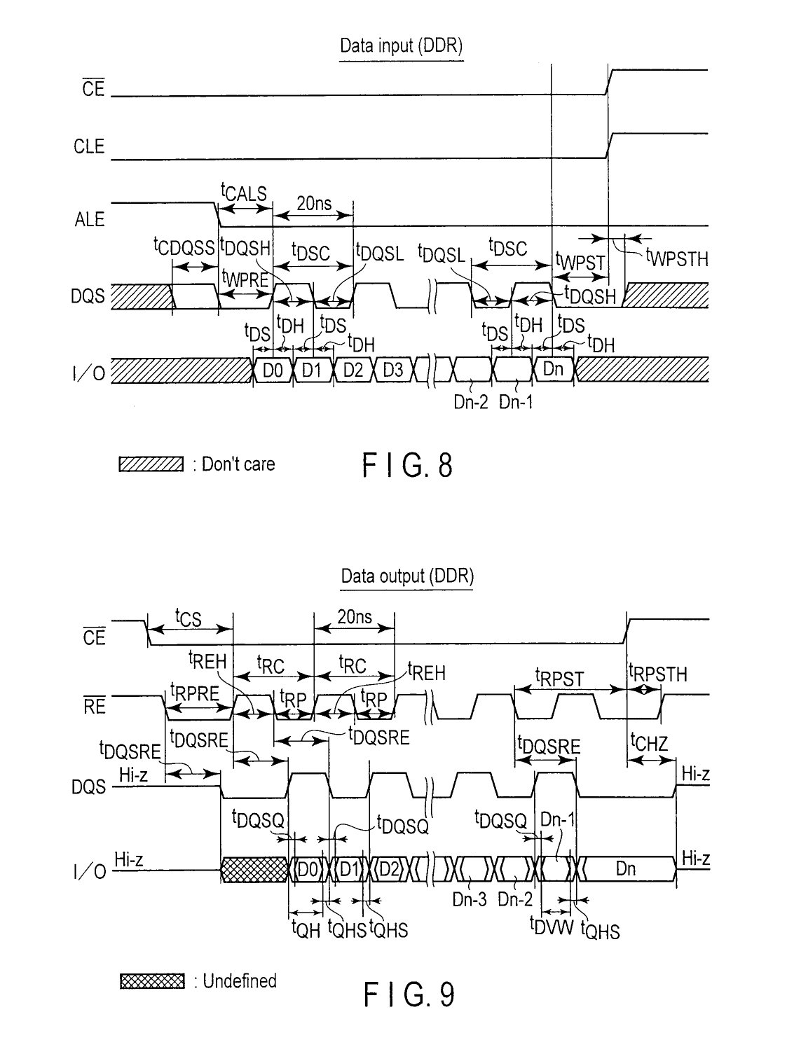

FIG. 8 is a timing chart illustrating a data input process in the DDR mode. The NAND flash memory 1 receives command latch enable signal CLE, chip enable signal /CE, address latch enable signal ALE and data strobe signal DQS as control signals from the host controller 2. In this case, t_{CALS} indicates CLE/ALE setup time, t_{CDQSS} indicates DQS setup time for starting data input, t_{WPRE} indicates a write preamble, t_{DSC} indicates data strobe cycle time, t_{DQSH} indicates DQS high-level width, t_{DQSL} indicates DQS low-level width, t_{WPST} indicates a write post-amble and t_{WPSTH} indicates write post-amble hold time.

As shown in FIG. 8, the controller 17 takes in input data D in response to both of the rising edge and falling edge of data strobe signal DQS. That is, the controller 17 performs a data input process by using the DDR mode with data strobe signal DQS used as a control signal. The cycle time (data strobe cycle time t_{DSC}) of data strobe signal DQS is 20 ns, for example. Therefore, in the data input process in the DDR mode, the transfer rate of 100 Mbps is realized.

FIG. 9 is a timing chart illustrating a data output process in the DDR mode. The NAND flash memory 1 receives chip enable signal /CE, read enable signal /RE and data strobe signal DQS as control signals from the host controller 2. In this case, t_{RPRE} indicates a read preamble, t_{RPST} indicates a read post-amble, t_{RPSTH} indicates read post-amble hold time, t_{DQSRE} indicates a time delay from /RE to DQS, t_{DQSQ} indicates a skew between data output and DQS, t_{QH} indicates output hold time from DQS, t_{QHS} indicates a DQS hold skew factor, t_{DVW} indicates an output data effective window, and Hi-z indicates high impedance.

As shown in FIG. 9, the controller 17 outputs data D in response to both of the rising edge and falling edge of data strobe signal DQS. That is, the controller 17 performs a data output process by using the DDR mode with data strobe signal DQS used as a control signal. The cycle time of data strobe signal DQS is the same as read cycle time t_{RC} and is 20 ns, for example. Therefore, in the data output process in the DDR mode, the transfer rate of 100 Mbps is realized.

### 3. Effect

As described above in detail, in the first embodiment, the controller 17 has the SDR mode to perform data transfer in response to one of the rising edge and falling edge of the control signal and the DDR mode to perform data transfer in response to both of the rising edge and falling edge of the control signal. Then, the controller 17 switches the SDR mode and DDR mode according to the switch command sequence supplied from the host controller 2.

Therefore, according to the first embodiment, the transfer rates in data input and data output can be enhanced by performing the data input process and data output process by using the DDR mode.

The DDR mode requires a transfer rate that is approximately twice that of the SDR mode. Therefore, in the DDR mode, the peak value (peak current) of the consumed current in data input and data output or the average consumed current in a data transfer period will be increased. If a large peak current occurs in the NAND flash memory, the power source voltage of a system including the NAND flash memory may be lowered and there occurs a possibility that the system is erroneously operated.

In the system in the above condition, the NAND flash memory can reduce the peak current by performing the data input process and data output process by using the SDR mode. As a result, the system can be suppressed from being erroneously operated.

Thus, since the NAND flash memory of this embodiment can easily switch the SDR mode and DDR mode according to the condition of the peripheral module, the effect that the data transfer rate can be increased and the system including the NAND flash memory can be suppressed from being erroneously operated can be achieved.

Further, in this embodiment, the control signal with the same cycle time (or the same frequency) is used in the SDR mode and DDR mode as a clock (control signal) used as a reference at the data transfer time. Therefore, the host controller 2 is not required to have a plurality of crystal oscillators for generating clocks and the cost may be lowered. The cycle times of the control signals in the SDR mode and DDR mode may be different.

### Second Embodiment

A second embodiment uses an SDR mode in a data input process and uses a DDR mode in a data output process to perform different data transfer modes in the data input process and data output process.

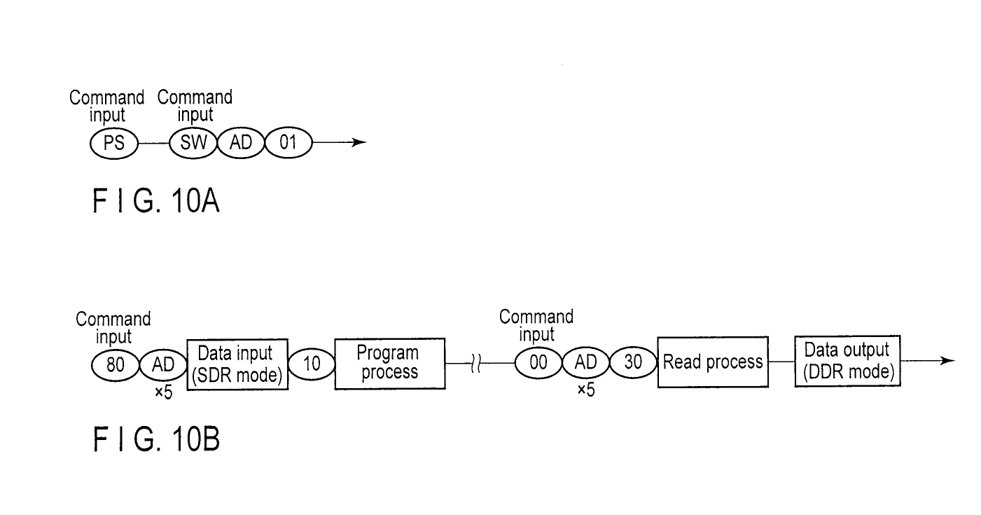

FIG. 10A is a flow diagram illustrating the operation of switching data input and data output to an SDR mode and DDR mode, respectively. First, a NAND flash memory 1 receives set command sequence PS from a host controller 2.

Then, a controller 17 receives a switch command sequence from the host controller 2. The switch command sequence includes switch command SW, address AD and parameter “01h”. The least significant bit of the parameter specifies a data transfer mode in the data output and the second bit from the least significant bit specifies a data transfer mode in the data input. Data “0” expresses the SDR mode and data “1” expresses the DDR mode. Since the lower two bits of parameter “01h” included in the switch command sequence of FIG. 10A are “01b”, the data input and data output are respectively specified to the SDR mode and DDR mode.

After interpreting the switch command sequence, the controller 17 overwrites mode data that sets the data input and data output to the SDR mode and DDR mode, respectively, to a data area 18A of a latch circuit 18. Then, the NAND flash memory 1 confirms mode data stored in the latch circuit 18 to perform the data input process by using the SDR mode and perform the data output process by using the DDR mode with respect to the host controller 2.

FIG. 10B is a flow diagram illustrating the data input operation in the SDR mode and the data output operation in the DDR mode. The NAND flash memory 1 receives a program command sequence and data from the host controller 2. The controller 17 performs a data input process by using the SDR mode in response to the program command sequence. The data input process is the same as that of FIG. 6. Then, the controller 17 writes data received from the host controller 2 to a memory cell array 10 in the page unit. Likewise, the program command sequence is repeatedly performed until all of write data items requested by the host controller 2 are written to the NAND flash memory 1.

Then, the NAND flash memory 1 receives a read command sequence from the host controller 2. The controller 17 reads data corresponding to an address from the memory cell array 10 in the page unit in response to the read command sequence. Next, the controller 17 performs a data output process by using the DDR mode. The data output process is the same as that of FIG. 9. Likewise, the read command sequence is repeatedly performed until all of read data items requested by the host controller 2 are read from the NAND flash memory 1.

Since it is required to set the threshold voltages of memory cell transistors with high precision in the program process of the NAND flash memory, a program stage configured by the operation of applying a program voltage and the verify operation is performed plural times. Therefore, the read time required for the read process in the NAND flash memory becomes shorter than the program time required for the program process. As a result, a time from the time when the host controller issues a read command sequence until it receives data can be reduced by performing the data output in the DDR mode.

Further, since it takes a relatively long time to perform the program process of the NAND flash memory, the time from the time when the host controller issues a program command sequence until data is programmed in the memory cell array cannot be significantly reduced even if the operation speed of data input is increased. Therefore, in this embodiment, the peak current of the NAND flash memory is reduced by using the SDR mode in the data input.

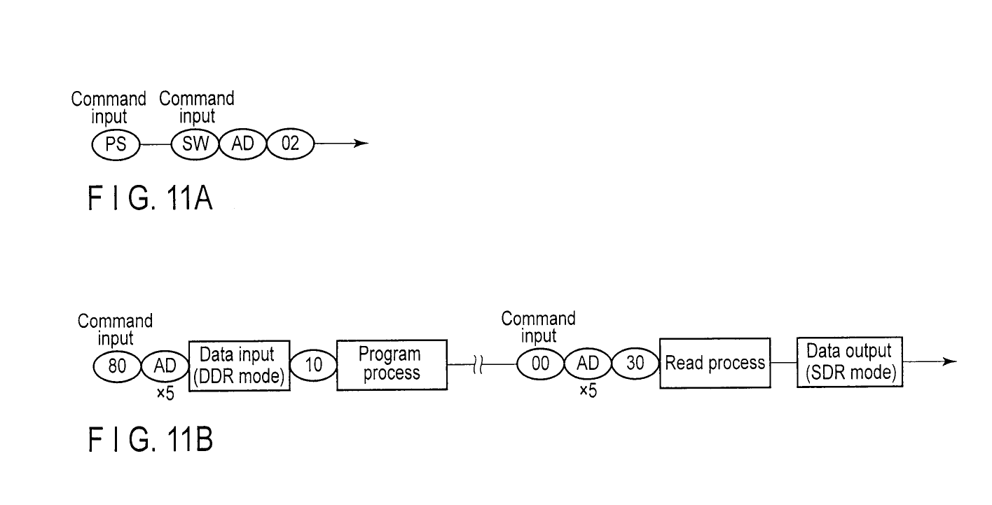

Further, the DDR mode and SDR mode can be used in the data input and data output, respectively. FIG. 11A is a flow diagram illustrating the operation of switching the data input and data output to the DDR mode and SDR mode, respectively. First, the NAND flash memory 1 receives set command sequence PS from the host controller 2.

Then, the controller 17 receives a switch command sequence from the host controller 2. The switch command sequence includes switch command SW, address AD and parameter “02h”. Since the lower two bits of parameter “02h” are “10b”, the data input and data output are respectively specified to the DDR mode and SDR mode.

After interpreting the switch command sequence, the controller 17 overwrites mode data that sets the data input and data output to the DDR mode and SDR mode, respectively, to the data area 18A of the latch circuit 18. Then, the NAND flash memory 1 confirms mode data stored in the latch circuit 18 to perform the data input process by using the DDR mode and perform the data output process by using the SDR mode with respect to the host controller 2.

FIG. 11B is a flow diagram illustrating the data input operation in the DDR mode and the data output operation in the SDR mode. The NAND flash memory 1 receives a program command sequence and data from the host controller 2. The controller 17 performs a data input process by using the DDR mode in response to the program command sequence. The data input process is the same as that of FIG. 8. Then, the controller 17 writes data received from the host controller 2 to the memory cell array 10 in the page unit. Likewise, the program command sequence is repeatedly performed until all of write data items requested by the host controller 2 are written to the NAND flash memory 1.

Subsequently, the NAND flash memory 1 receives a read command sequence from the host controller 2. The controller 17 reads data corresponding to an address from the memory cell array 10 in the page unit in response to the read command sequence. Next, the controller 17 performs a data output process by using the SDR mode. The data output process is the same as that of FIG. 7. Likewise, the read command sequence is repeatedly performed until all of read data items requested by the host controller 2 are read from the NAND flash memory 1.

(Effect)

As described above in detail, in the second embodiment, the controller 17 has the SDR mode to perform data transfer in response to one of the rising edge and falling edge of the control signal and the DDR mode to perform data transfer in response to both of the rising edge and falling edge of the control signal. Then, the controller 17 switches the SDR mode and DDR mode to use the SDR mode in the data input and use the DDR mode in the data output.

Therefore, according to the second embodiment, the SDR mode and DDR mode are switched according to the operation characteristics of the NAND flash memory 1 to set the SDR mode in correspondence to the program process that takes a long time and set the DDR mode in correspondence to the read process that does not take a long time in comparison with the program process. Therefore, the peak current can be reduced while enhancing the data transfer rate. The other effects are the same as those of the first embodiment.

Further, the DDR mode may be used for the data input, and the SDR mode may be used for the data output.

### Third Embodiment

A third embodiment uses a plurality of NAND flash memories in a memory system, such as an SSD (Solid State Drive).

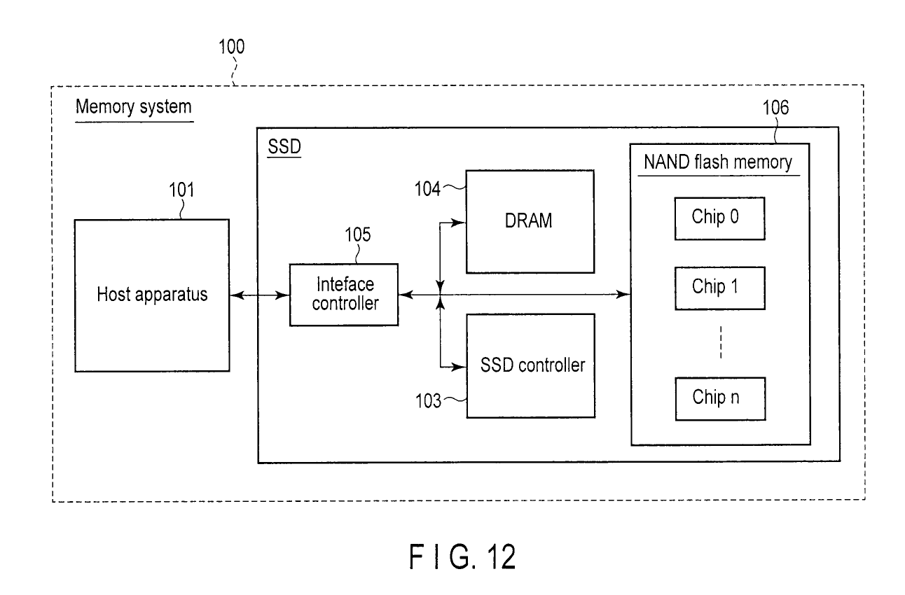

FIG. 12 is a block diagram of a memory system according to a third embodiment. A memory system 100 includes a host apparatus 101 and an SSD 102. The SSD 102 includes an SSD controller 103, DRAM (Dynamic Random Access Memory) 104, an interface controller 105, and a plurality of NAND flash memory chips 106.

The interface controller 105 is connected to the host apparatus 101. The interface controller 105 may be conformed to at least one of the ATA (Advanced Technology Attachment) standard, the SAS (Serial Attached SCSI) standard and the PCI Express (Peripheral Component Interconnect) standard. The host apparatus 101 is capable of communicating with the SSD 102 via the interface controller 105.

The SSD controller 103 controls overall functions of the SSD 102 by using at least one of firmware and hardware resources. For example, the SSD controller 103 may include a CPU (Central Processing Unit), a SRAM (Static Random Access Memory) for storing the firmware, a first memory controller for the DRAM 104, a second memory controller for the plurality of NAND flash memory chips 106, ECC (Error Checking and Correcting) circuit. The SSD controller 103 controls the DRAM 104, the interface controller 105 and the plurality of NAND flash memory chips 106.

The DRAM may be used as a data cache or a data buffer for the plurality of NAND flash memory chips 106. The DRAM also may be used to temporally storing management data of the SSD 102, such as a logical to physical translation table. The logical to physical translation table associates logical addresses input from the host apparatus 101 with physical addresses of the plurality of NAND flash memory chips 106.

The plurality of NAND flash memory chips 106 may be comprised of n number of chips. Each one of the plurality of NAND flash memory chips 106 may be conformed to at least one of the first and second embodiments. That is, each one of the plurality of NAND flash memory chips 106 may change its operation mode to SDR mode or DDR mode according to the switch command sequence.

In one embodiment, the SSD controller 103 may include a monitoring module that monitors at least one of a current consumed in the SSD 102, a power consumed in the SSD 102 and a temperature in the SSD 102. The SSD controller 103 may changes the operation mode based on the above parameters.

For example, the SSD controller 103 changes its operation mode to the SDR mode when the current or power consumed in the SSD is greater than a predetermined threshold. Furthermore, the SSD controller 103 changes its operation mode to the SDR mode when the temperature in the SSD is higher than a predetermined threshold. The SSD controller 103 may changes the plurality of NAND flash memory chips 106 to the SDR mode all together or may changes only a part of the plurality of NAND flash memory chips 106 to the SDR mode.

In one embodiment, the SSD controller 103 may use the SDR mode when inputting and outputting data to and from the plurality of NAND flash memory chips 106.

In one embodiment, the SSD controller 103 may use the DDR mode when inputting and outputting data to and from the plurality of NAND flash memory chips 106.

In one embodiment, the SSD controller 103 may use the SDR mode when inputting data to the plurality of NAND flash memory chips 106 and may use the DDR mode when outputting data from the plurality of NAND flash memory chips 106.

In one embodiment, the SSD controller 103 may use the DDR mode when writing user data to the plurality of NAND flash memory chips 106 and may use the SDR mode when writing the management data to the plurality of NAND flash memory chips 106.

In one embodiment, each one of the plurality of NAND flash memory chips 106 may be connected to the SSD controller 103 via an independent channel. Each channel includes the I/O lines and the control signal lines. The SSD controller 103 may use the SDR mode for one channel and use the DDR mode for another channel.

In one embodiment, the ECC circuit is capable of detecting or correcting data readout from the plurality of NAND flash memory chips 106. The SSD controller 103 may enable the ECC circuit when using the DDR mode and may disable the ECC circuit when using the SDR mode. On the other hand, the SSD controller 103 may disable the ECC circuit when using the DDR mode and may enable the ECC circuit when using the SDR mode.

In one embodiment, the plurality of NAND flash memory chips 106 may be used in a pseudo SLC (Single Level Cell) mode or an MLC (Multi Level Cell) mode. In the pseudo SLC mode, one memory cell transistor stores single bit even if the memory cell is capable of storing multiple bits. In the MLC mode, one memory cell transistor stores multiple bits. An average data programming time required for writing data in the pseudo SLC mode is shorter than that of the MLC mode. The SSD controller 103 may write data to the plurality of NAND flash memory chips 106 in the MLC mode when using the SDR mode and may write data to the plurality of NAND flash memory chips 106 in the SLC mode when using the DDR mode. On the other hand, the SSD controller 103 may write data to the plurality of NAND flash memory chips 106 in the SLC mode when using the SDR mode and may write data to the plurality of NAND flash memory chips 106 in the MLC mode when using the DDR mode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonvolatile semiconductor memory device comprising:
a nonvolatile memory; and
a controller having a first mode to perform data transfer in response to one of a rising edge and falling edge of a first control signal and a second mode to perform data transfer in response to both of a rising edge and falling edge of a second control signal,
wherein the controller switches the first and second modes in data input and data output.

2. The device of claim 1, wherein the controller receives a command sequence including a command and parameter and switches the first and second modes based on the command sequence.

3. The device of claim 1, wherein the controller receives a parameter and switches the first and second modes based on the parameter.

4. The device of claim 1, wherein the controller receives a command and switches the first and second modes based on the command.

5. The device of claim 1, wherein the second control signal has the same frequency as that of the first control signal.

6. The device of claim 1, wherein the controller switches the first and second modes to use the first mode in data input and use the second mode in data output.

7. The device of claim 1, wherein the controller switches the first and second modes to use the second mode in data input and use the first mode in data output.

8. The device of claim 1, further comprising a latch circuit configured to hold mode data indicating a data transfer mode,
wherein the controller performs data transfer with reference to the mode data of the latch circuit.

9. The device of claim 8, wherein
the nonvolatile memory includes a storage area configured to store a boot program, and
the controller sets the mode data to initial data based on the boot program at boot time.

10. The device of claim 8, wherein the controller overwrites the mode data of the latch circuit when the transfer mode is switched.

11. The device of claim 1, wherein the nonvolatile memory is a NAND flash memory.

12. A memory system comprising:
a plurality of nonvolatile memory chips capable of operating in a first mode to perform data transfer in response to one of a rising edge and falling edge of a first control signal and a second mode to perform data transfer in response to both of a rising edge and falling edge of a second control signal; and
a controller connected to the nonvolatile memory chips and configured to issue a switch command sequence including at least one of a command and a parameter,
wherein the nonvolatile memory chips are capable of switching the first and second modes based on the switch command sequence.

13. The system of claim 12, wherein
the controller includes a monitoring module that monitors a current consumed in the memory system, and
the controller issues the switch command sequence to use the first mode when the monitoring module determines that the current is greater than a predetermined threshold.

14. The system of claim 12, wherein
the controller includes a monitoring module that monitors a power consumed in the memory system, and
the controller issues the switch command sequence to use the first mode when the monitoring module determines that the power is greater than a predetermined threshold.

15. The system of claim 12, wherein
the controller includes a monitoring module that monitors a temperature in the memory system, and
the controller issues the switch command sequence to use the first mode when the monitoring module determines that the temperature is higher than a predetermined threshold.

16. The system of claim 12, wherein the controller issues the switch command sequence to use the first mode when writing management data of the memory system to the nonvolatile memory chips and to use the second mode when writing user data to the nonvolatile memory chips.

17. The system of claim 12, wherein each one of the nonvolatile memory chips is a NAND flash memory.

18. The system of claim 17, wherein the memory system is an SSD (Solid State Drive).
